(19) United States
(12) Patent Application Publication
(10) Pub. No.: US 2022/0045864 A1
(43) Pub. Date: Feb. 10, 2022

(54) VERACITY MEASURES FOR ONLINE DISCOURSE

(71) Applicants: Stephen B. Heppe, Hood River, OR (US); Kenan G. Heppe, Hood River, OR (US); Trevor Wright, Hood River, OR (US)

(72) Inventors: Stephen B. Heppe, Hood River, OR (US); Kenan G. Heppe, Hood River, OR (US); Trevor Wright, Hood River, OR (US)

(21) Appl. No.: 16/984,358

(22) Filed: Aug. 4, 2020

(51) Int. Cl. H04L 9/32; G06F 16/27; G06F 16/22

(52) U.S. Cl. CPC H04L 9/3247; G06F 16/2272; G06F 16/27

(57) ABSTRACT

Systems and methods are disclosed for evaluating the veracity of online content, particularly in cases where the online content is signed/authenticated by one or more digital signatures associated with one or more users. Also disclosed are systems and methods for storing and retrieving authenticated content, and displaying authenticated content referencing other authenticated content.

### RELATED DOCUMENTS

The present application incorporates by reference all the teachings of U.S. Pat. Nos. 9,639,841, 10,033,537, and 10,686,609. Also relevant to the teachings herein, are existing industry standards for secure exchange of data, including but not limited to ITU-T X.509v3, RFC 5280, the Digital Signature Algorithm (DSA) developed by NIST, TLS/SSL, and HTTPS.

### BACKGROUND

With the ongoing public complaints of “fake news” (the deliberate creation and sharing of false and/or manipulated information that is intended to deceive and mislead audiences), and the increasing prevalence of fake or doctored videos and other fake or doctored online/electronic documents, there is a need for new measures to increase the confidence that online media, offered as fact-based, are actually representative of true events and/or points-of-view. The need for individual users and organizations to counter fake news, sort fact from fiction in third-party accounts, and protect their own reputations, leads to significant expenditures of time and other resources. Conversely, “bad actors” (e.g., those attempting to promulgate fake news) spend large sums of money, and they have a measurable negative impact on social stability and the worldwide economy. The Mueller Report found that during the 2016 presidential election in the United States, the Russian Internet Research Agency (IRA) purchased over 3,500 advertisements, totaling $100,000, in a bid to provoke and amplify political and social discord in the United States. Fake news, advertisements, and Twitter attacks can be used to discredit journalists, influence policy changes, and impact elections. The security firm, Symantec, has reported three cases of “deepfaked” audio of chief executives designed to trick senior financial controllers into transferring cash. Mike Paul, president of Reputation Doctor, said that “Fake news today is like a modern-day tech suicide bomber in the worlds of communication, reputation and branding. It only takes one well-planned success to hurt a lot of people or an organization.”

News organizations (and other entities hosting web sites allowing public viewing, feedback and postings) would prefer a high level of truthful discourse as well as a dynamic, energetic online conversation that does not stifle discussion or dissent, yet minimizes the number of low quality posts as well as the potential for exploitation by users attempting to spread fake news. Many news organizations (and other entities) also hold a commitment to the First Amendment rights protected by the US Constitution, but would also like to minimize the number of falsified postings that, in aggregate, reduce the confidence of the public in online institutions. Attempting to satisfy these diverse objectives, in the context of an online forum that generally allows for a degree of anonymity, is recognized as a challenging problem. A popular site could receive hundreds or even thousands of posts per day, making human mediation and pre-screening a costly proposition. Currently, in attempting to assess the quality of a post, and support decision-making regarding posting or removal, many sites and organizations rely on diverse strategies such as human mediation by individuals, groups, or ad hoc expert panels (generalizing the principles of, e.g., the Delphi method), or automatic or semi-automatic assessment of offered content with regard to subject matter, profanity, community standards, and other metrics. Many sites also assess the provenance of offered content—the status of a user offering a post. For example, recognized experts in a field, or users that have achieved a measure of community status on a site, may be accorded a higher level of trust than other users. However, these methods do not directly address the issue of fake news, or ensure the fidelity of cited concepts and ideas as they are discussed, referenced, and repeated by multiple human users.

U.S. Pat. No. 9,639,841 teaches, inter alia, systems and methods that allow a user (e.g., “Bob”) to gain wide recognition for high quality discourse, possess a cryptographically secure certificate of quality that can be displayed at will, and tag his posts with a cryptographically secure digital signature—a tag constructed over an input string using a private key. However, this patent does not fully address the issue of a post that falsely purports to represent Bob's views and/or associated content. While such a post would not contain Bob's cryptographically secure digital signature, viewers might be unsure of its provenance (and Bob might have to expend significant time and energy demonstrating that such a post was not actually his, or representative of his views and/or actions).

U.S. Pat. No. 10,033,537 teaches, inter alia, systems and methods that provide for a “chain of evidence” in online postings and discussions, allowing viewers to verify the provenance of original source materials and postings in cases where the original material has been cryptographically secured. However, this patent does not fully address a post that falsely purports to represent the views and/or associated content of a user (such as Bob). While a chain of evidence might be absent in such a situation, or apparently present but incomplete, it might be difficult for an original content provider (such as Bob) to prove that source material in a particular posting was not actually his own work, or representative of his own views and/or actions.

Furthermore, in cases where original and cryptographically secured content has been modified, with the modification properly captured in accordance with the teachings of U.S. Pat. No. 10,033,537, there is still an unmet need for an original content provider to tag or “validate” the modification as continuing to represent his/her views.

Thus, there is a need for systems and methods that would allow a user to easily verify ownership or association with content after it has been posted (i.e., “after the fact”), and also to dispute ownership or association with content that is falsified or manipulated. There is also a need for systems and methods that would allow a user or “content consumer” to understand the flow of an online discussion with regard to cited content, the apparent veracity of an initial post, and the veracity of commentary that an initial post has accumulated.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a veracity server as described herein, and interactions with the veracity server over the Internet according to an embodiment of the principles described herein;

FIG. 2 is a block diagram illustrating a relationship of source material cited in an exemplary comment that could be indexed according to an embodiment of the principles described herein;

FIG. 3 is a block diagram illustrating a plurality of tools used to display an existing post and some or all of its related commentary to a user according to an embodiment of the principles described herein;

FIG. 4 is a flow diagram illustrating two potential methods that a “bad actor” could employ to try to avoid an accumulation of commentary on an original post according to an embodiment of the principles described herein; and

FIG. 5 is a block diagram illustrating two original posts and several related comments according to an embodiment of the principles described herein.

Throughout the drawings, identical reference numbers designate similar, but not necessarily identical, elements.

### DETAILED DESCRIPTION OF THE DRAWINGS

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As noted above, the teachings of U.S. Pat. Nos. 9,639,841, 10,033,537, and 10,686,609 are incorporated herein by reference in their entirety. These patents, among other things, taught methods to assess the quality of a user's post; generate cryptographically secure certificates that could be awarded to users by a web site, and displayed by users to other web sites as a demonstration of excellence; and encapsulating cryptographic hashes to form a secure “chain of evidence” to protect the veracity of online postings. Two industry standards that address the generation and use of cryptographically secure certificates are ITU-T X.509v3 and RFC 5280; however, other methods of generating and verifying certificates are also feasible.

In some cases, a user preparing a post may wish to secure the advance endorsement of an owner, author or developer of pre-existing content (or an interested party, such as a person who has been recorded). In other cases, an owner, author or developer of pre-existing content (e.g. pre-existing records), or another interested party may wish to intervene “after the fact”—after the content has been posted, reposted, or modified—in order to attest to its veracity (i.e., “My name is Bob, and I approved of this message”). In yet other cases, a source may wish to intervene after the fact, in order to dispute the accuracy or authenticity of a post. This could occur, for example, if a quote attributed to a source has been modified or is incomplete. Furthermore, a person's words, image, or other related content may have been taken out-of-context, or mashed with other content that lends an improper meaning or intent. For example, an accurate quote from a political figure might be mashed with an image from a different time and place (or generally, a different context), to impart a false and improper meaning or sentiment to the original quote. Other means of falsification include, inter alia, improper timing of video clips (either too fast or too slow), and so-called “deep fakes.”

If a source cannot force the removal of the material from online servers, he or she may wish to flag the material so that interested viewers can be alerted to the improper context. In a football metaphor, this might be considered analogous to “throwing a flag.” Human fact-checkers can also use the systems and methods discussed herein, to review referenced material, assess the veracity of online actors, and build commentary on material posted by others.

### Pre-Planned Endorsements

Relying in part on the teachings of U.S. Pat. No. 10,033,537, if a content developer (“Vicky”) wishes to include an endorsement of a source (“Dave”), the two could actively collaborate. For example, Vicky could develop her desired content with as much underlying content of Dave as she wishes, with commentary as desired, and offer Dave the opportunity to review and “sign” her work after she herself has signed/protected it (or a hash of it) with her own private key. Vicky's digital signature—the encrypted version of her work (or a hash of her work)—can only be decrypted with her public key; successful decryption, by any third party with access to her public key, indicates that the work is hers. Dave's additional signature using his own private key, with or without explicit embedded commentary, represents an endorsement that he agrees with the content (“My name is Dave, and I approved of this message”). Only Dave can provide this endorsement by affixing an encrypted version of e.g. a hash of Vicky's post (possibly with additional commentary) generated with his own private key. Vicky could then distribute the doubly-protected content (with or without an outer encapsulating signature) as her own work with the endorsement of Dave. Others would then be free to use it, with or without modification. For example, a string of “good actors” could copy or refer to the original source material, for example by “sharing” it e.g. on Facebook®, and even paraphrase it, with suitable bibliographic data and/or pointers for verification. The method described above can be extended to multiple contributors, collaborators, and/or endorsers.

Endorsements and Disputes after Posting

If Dave learns of Vicky's work after it has entered the public domain, but still wishes to endorse that work, it would be straightforward for Dave to append his own protected hash of Vicky's work, encrypted with his private key, and re-post the augmented content. In one embodiment, such a hash of Vicky's work, without additional commentary, serves as an implicit positive endorsement by Dave. In another embodiment, Dave may include a message field indicating the type of commentary—e.g., positive endorsement, negative endorsement/challenge, or informational. However, Dave's endorsement using either of these methods might not reach all of Vicky's primary followers (and would be unlikely to reach a significant fraction of e.g. her second- and third-hand followers). He could send his endorsed version back to Vicky for reposting, but this incurs additional effort on the part of Vicky and her followers, and still might not reach all of Vicky's direct and indirect followers (some of whom may ignore the second post).

An ineffective or poorly-distributed positive endorsement might be considered merely an annoyance; however, an ineffective or poorly-distributed challenge (i.e., associated with an unintentional or malicious misquote, or source material presented out-of-context) may have more serious consequences. It can be difficult to “correct the record” in online media, especially since false and/or salacious content can propagate more quickly, and more widely, that the truth.

The need for an effective means of dispute can arise, even if Vicky's original post is perfectly accurate. In particular, one or more of Vicky's direct or indirect followers could modify her post, or combine her post with additional content, in such a way that the original meaning is distorted. Even if Vicky's original post is retained in its entirety, but with added material, it might be possible to change the apparent meaning of the content without actually “breaking” the protections provided by Vicky and Dave. The added material could comprise, inter alia, text, figures, images, video overlays or clips, or audio tracks. While it would be clear that neither Vicky nor Dave had “signed” the entire modified post, a viewer or consumer would have to do some research to determine the nature of the change.

It is also conceivable that a malicious actor could modify some or all of Vicky's original post, perhaps stripping some or all of Vicky's protections which would no longer be verifiable. Any such modification would also “break” Dave's overall endorsement. However, depending on the nature of the modification, and how Vicky had chosen to protect her content (including Dave's source material), it might be difficult for a subsequent viewer or consumer to determine the nature of the change. An extreme example would be a screen shot of a Facebook post by Vicky (possibly one that textually alludes to an endorsement by Dave), which is then edited to change the visual content. Such a coarse manipulation would break any embedded or referenced signatures by both Vicky and Dave, but might superficially appear to be genuine (at least until a third party attempts to verify a signature).

After-the-fact endorsements, and challenges, can be facilitated by proper care on the part of online actors (for example, giving suitable weight to a full chain of authentication hashes), and the use of a “veracity server” as described herein.

### The Veracity Server

In the embodiments described herein, a veracity server keeps track of e.g. digital signatures, bibliographic data and/or pointers for authenticated content, and endorsements and “negative endorsements” (i.e., flags and challenges) associated with that content. A veracity server can be hosted by a web site such as WebOneNews or ScienceOne (as described in the previously-cited patents), or by an independent organization. The functions of a veracity server can be integrated with the functions of a pre-existing server, such as may be hosted by an organization such as WebOneNews or ScienceOne. Depending on its detailed configuration as determined by its owner or operator, it could accept data from the general public, or it could be limited to special groups. Developers of content could choose to ensure the availability of their authentication data by proactively submitting their authentication and bibliographic data/pointers to the veracity server for subsequent retrieval by the public—perhaps for a fee. Alternatively, or in addition, a veracity server could be configured to actively search other online servers for suitable content (much as Google® accumulates content). Furthermore, in addition to (optionally) charging fees, the organization that operates the veracity server could support itself by donations or through advertising revenue (among other ways).

The veracity server provides a central repository (or one of a relatively small number of repositories) where authenticated hashes or hash manifests and bibliographic data/pointers can be stored, and searched-for and retrieved, along with any associated endorsements or negative endorsements (flags or challenges). The veracity server may also store the underlying content in an embodiment. In alternative embodiments, the underlying content may not be required to be stored for its basic functions.

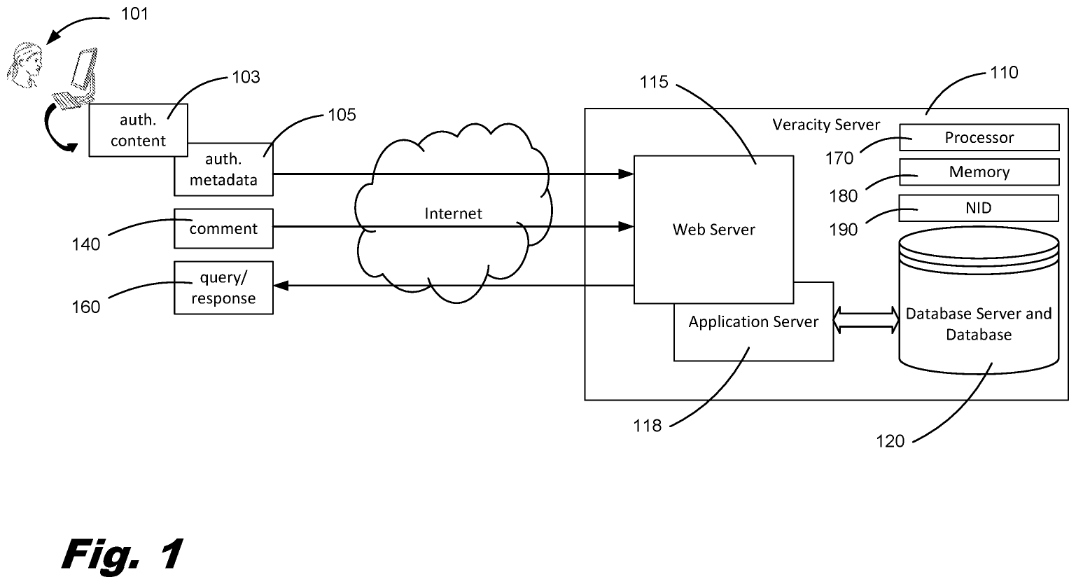

Referring to FIG. 1, in an embodiment, a user 101 (“Vicky”) may generate an authenticated post comprising content 103 authenticated with “authentication metadata” 105, including e.g. a hash manifest authenticated/signed with the user's private key. The authentication metadata may also include bibliographic data for source material Vicky has referenced (including URLs and digital signatures for authenticated work of others), as well as a site or URL where Vicky's post may be found (e.g., WebOneNews). In this exemplary use case, the authenticated content 103 contains some source material from “Dave.” In addition to optionally posting her document on some other site (e.g., WebOneNews), Vicky posts or uploads the post along with its authentication metadata 105 to the veracity server 110 (which may be one of several veracity servers available to her) using an internet protocol as known in the art for transmitting messages via the Internet. In an alternative embodiment, the authentication metadata 105 comprises one or more pointers to online repositories where the authenticated content is stored, and only the authentication metadata is uploaded to the veracity server. Methods for authenticating content are discussed in U.S. Pat. No. 10,033,537, as well as e.g. ITU-T X.509v3 and RFC 5280. The veracity server 110 comprises web server(s) 115, application server(s) 118, and database server(s) with associated database(s) 120. In an embodiment, the veracity server 110 further includes a processor 170 and a memory 180. The processor 170 may be any type of data processing device such as a central processing unit (CPU), a graphics-processing unit (GPU), control logic or some combination of the same. Any of the processing resources may operate to execute code that is either firmware or software code. Moreover, veracity server 110 may include memory 180 such as main memory, static memory, a drive unit, or the computer readable medium. In an embodiment, the memory 180 may include a solid-state memory such as a memory card or other package that houses one or more non-volatile read-only memories. In an embodiment, the memory 180 may be a random-access memory or other volatile re-writable memory. Additionally, the memory 180 may include a magneto-optical or optical medium, such as a disk or tapes or other storage device to store information received via carrier wave signals such as a signal communicated over a transmission medium. Furthermore, a memory 180 may store information received from distributed network resources such as from a cloud-based environment. Accordingly, the present specification is considered to include any type of memory 180 or other equivalents and successor media, in which data or instructions may be stored.

The veracity server 110 may further include a network interface device (NID) 190. The network interface device 190 may provide connectivity to, via the Internet, a network, e.g., a wide area network (WAN), a local area network (LAN), wireless local area network (WLAN), a wireless personal area network (WPAN), a wireless wide area network (WWAN), or other networks. Connectivity may be via wired or wireless connection.

In one embodiment, if Vicky generates an authenticated post on a website such as WebOneNews, that site automatically pushes the post to the veracity server so that Vicky does not have to perform this task manually. In one such embodiment, the site Vicky accesses directly to generate her authenticated post (e.g., WebOneNews) accesses the veracity server as a certification authority for the authentication. In another embodiment, a combination of keys is used to create a signature. In any case, once the veracity server learns of Vicky's authenticated post, it stores and indexes Vicky's uploaded data at least according to the numerical value of the digitally signed authentication data generated using the one or several private keys. Additional indexing may be provided based on other parameters, including without limitation the date and time of posting, the date and time of creation (if known), Vicky's email address or other contact information, and other metadata. In an embodiment, the veracity server timestamps incoming messages and records to be logged with a UNIX timestamp (i.e., the number of elapsed seconds since UTC midnight leading into Jan. 1, 1970). However, it is recognized that metadata for times of creation, for secure posts generated by users, may optionally employ other time standards and systems with differing degrees of accuracy and differing offsets compared to the time standard maintained by the veracity server. Indexing parameters and strategies may be optimized for observed usage patterns and content, and may differ from one subject matter domain to another. For example, the indexing parameters and indexing strategies employed for postings related to current events on such general-purpose platforms as Facebook®, Twitter®, and Reddit® may be different from those employed on postings related to scientific research. Indeed, individual platforms or veracity servers may apply different indexing parameters and strategies for different groups and subgroups of posts indexed on the server, as a function of e.g. subject matter, type of content (e.g., text, video, audio), the number and complexity of embedded references to other authenticated postings, the volume of commentary received, and the types of queries received.

It should be understood that the web server(s) 115, application server(s) 118, and data base server(s) with associated database(s) 120, can be integrated in a single server device or distributed across multiple server devices, in a single location or multiple locations, and may be proliferated for purposes of data reliability as well as load handling. Each server comprises at least one processor with associated memory or memories containing software as well as data representing ongoing and/or archived operations. The web server(s) 115, whether configured as a dedicated server or integrated into a server supporting multiple other functions, comprise(s) at least one network interface for communication over the Internet (note: in alternative embodiments, the web server(s) may be replaced or augmented with a network interface adapted to a network other than the Internet). The application server(s) 118, whether configured as a dedicated server or integrated into a server supporting multiple other functions, comprise(s) processors and associated memory with software (and also real-time operating data) adapted to support query/response of authenticated posts and content (or data referencing such authenticated posts and content), acceptance of new authenticated posts and content (or data referencing such authenticated posts and content), indexing and cross-indexing of posts and content (or referencing data) it has accepted for archiving, and query/response of information it has archived. In some embodiments, the application server(s) 118 also support authentication (digital signing) and evaluation of metrics of veracity as described herein. The database server(s) with associated database(s) 120 comprise at least one processor with associated memory adapted for achieving of authenticated posts and content (or data referencing authenticated posts and content), and retrieving that information upon demand. Furthermore, in some embodiments, multiple veracity servers may be networked together to allow one veracity server to query another veracity server in the event, e.g., that it receives a user/client query with an unrecognized index.

Those of skill in the art of networked data communications will recognize that the internet protocol (IP) mentioned above is typically part of a larger “layered” suite of protocols used for end-to-end communications and application support between two communication end-points, the larger suite of protocols also comprising protocols for data communication over individual data links, as well as transport-layer and application layer services and functions. These layered protocols are typically described within a conceptual framework such as the ISO model of Open System Interconnection (OSI), or the Internet's TCP/IP protocol stack. Specific protocols typically used in a wired internet context include, inter alia, IPv4, IPv6, TCP and UDP. Related protocols also exist for specialized domains such as wireless and cellular communications, which may be used to support or extend internet connectivity.

Once Vicky has digitally signed her post (or caused it to be signed by another), it cannot be edited without violating the authentication (even by Vicky). In one embodiment comprising a web browser adapted to view such authenticated content, if an editing button is provided, it is “grayed-out.” For example, if Vicky retrieves her authenticated post and wishes to change it—perhaps by inserting a comma, or adding an additional image, she cannot do so. However, Vicky (and others) could create a new post or comment that references or incorporates the original post. Vicky could indicate, for example, that she also wants to distribute an additional image of Dave, or apologize for a grammatical error. Vicky (and others) can also cite or embed a portion of her original post in a new post or a comment. However, depending on how Vicky had chosen to protect her original post, and how the citing/embedding is accomplished, the cited/embedded content may or may not be authenticated as previously belonging to Vicky. For example, if Vicky has only provided a single hash and her digital signature for her entire post, any portion of the content would be unauthenticated, even if some accompanying bibliographic data indicates that it came from Vicky's authenticated post. On the other hand, if Vicky has provided a hash manifest with every image and textual sentence separately protected, a tool adapted for the purpose could cite or embed a protected portion of the original post in a way that would verify the citation was authentic (for example, by embedding the protected content along with its hash, and pointing to a particular entry of the hash manifest of Vicky's original post).

If Dave subsequently learns of Vicky's post on WebOneNews, Dave can make note of Vicky's digitally signed authentication data (here “digital signature”) and send a secure endorsement 140 to the veracity server. The secure endorsement would include Vicky's digital signature (which is effectively a unique fingerprint or watermark for Vicky's post), Dave's public ID and positive endorsement, and a hash of Vicky's digital signature and possibly other data created or referenced by Dave. The secure endorsement is signed and protected by an “outer” digital signature generated with Dave's private key. This secure endorsement can only be generated by Dave. Upon receiving the secure endorsement (a particular type of comment) 140, the veracity server recognizes that the endorsement comprises nested content—the content protected by Dave's outer digital signature contains at least one other digital signature (Vicky's). Upon recognizing the nested nature of the endorsement (e.g., a nested post), the veracity server parses the content to extract e.g. Vicky's inner digital signature and the data protected by Vicky's inner signature. The veracity server then checks its database (local or extended) to see if it has already indexed Vicky's signature and protected data. If it has, the veracity server records Dave's authenticated endorsement (at least its metadata) indexed by his digital signature, and associates Dave's endorsement with Vicky's previously-indexed record, cross-indexing each against the other for ease of subsequent retrieval. In one embodiment, as with Vicky's original post as noted above, the veracity server records the time of arrival of Dave's endorsement with a UNIX timestamp. If, on the other hand, it has not previously indexed Vicky's signature and protected data, it proceeds to do so based on the endorsement 140 from Dave (which includes Vicky's unique digital signature for her posted work). It also generates the associated record for Dave's endorsement. In this case, the recorded time of posting for both Vicky's original post and Dave's endorsement is the time at which Dave's endorsement was received, although the times of creation (if they are identified in the endorsement 140) may be different.

Thus, the reader will appreciate that it is not necessary for the veracity server to have previously indexed an authenticated post, in order to handle a comment on the post. Furthermore, while the above description indicated that Vicky's signature and protected data were written into the database before Dave's signature and comment, the reader will also appreciate that the order of the writing operations, into the database, could be reversed in the case where Vicky's original post was not already recorded.

Subsequently, if a third party wishes to check the veracity of Vicky's post and her handling of Dave's source material, the third party (“Michael”) can query the veracity server using Vicky's digital signature as an index, and retrieve Dave's endorsement along with the time of the original post (or at least, the time of Dave's endorsement upload, if the original post was not previously logged). The query/response is indicated as item 160 in FIG. 1. The endorsement applies to Vicky's original post (whatever is referenced in Dave's endorsement), not any subsequent modifications.

If Dave learns of Vicky's post and feels it does not properly represent or characterize his source material, he could simply upload a negative endorsement (a “flag” or “challenge”) using the same general method as described above for a positive endorsement (but indicating instead that the original post is problematic). However, this leaves open the issue of a “he said, she said” dispute, and fails to particularly identify the problematic element of the original post. In order to overcome this problem, Dave can provide additional information supporting his objection in his comment 140, or a hash manifest and pointer to an online repository where such information can be found, and this additional information would be logged and made available to third parties by the veracity server. The additional information could be a textual description—for example, pointing out that a video clip was manipulated, edited, sped up or slowed-down, or that it was juxtaposed with other material that causes the clip to be mis-interpreted in the apparent context. In some cases, this could include explicit reference/citation of the video metadata. If Dave's public speech or writings have been improperly paraphrased, Dave could provide a pointer to the original source material (with explanation). If Vicky's post attributes a thought or statement to Dave which Dave believes is inappropriate or incorrect, he can provide contrary data. If Vicky's post purports to place Dave at a particular place at a particular time, which is incorrect, Dave could possibly provide an alibi (perhaps supported by reference to his own location tracking information, or publicly-disclosable business information such as meeting locations and attendees, or facial recognition software indicating that an apparent likeness contained in Vicky's post has low probability of being Dave, or testimonials of others, or other available data). All of this information can be uploaded to the veracity server, or referenced with a suitable hash manifest and pointer to an online repository, and then referenced to Vicky's original post, with Dave's digital signature indicating his authorship of the comment. It is then available for any third-party query/response.

In regard to location tracking information that Dave might rely on, to demonstrate that he was not at a particular place at a particular time, one option is to rely on a location tracking service or application that accesses the location determination capability of modern cell phones, which in turn depends on various underlying technologies such as GPS, timing and trilateration measurements with respect to local cell sites, and proximity to known WiFi access points.

In regard to facial recognition software that could be used to counter an incorrect post, this technology is already present in various online services such as e.g. TikTok®, and could be adapted to generate a “likeness score” that could, in many cases, provide at least partial evidence that an apparent likeness was not actually Dave.

Of course, it is possible that Vicky's original post is accurate (she is a “good actor”), but her post is subsequently modified by a thoughtless, careless, or malicious individual (“Zed”). In this case, her original signature will be “broken”, and the modified post is either without proper authentication, or it will carry a signature generated by Zed. Both Vicky and Dave can upload negative endorsements (“flags”) against this post, whenever they are made aware of Zed's post.

The veracity server is not limited to a single endorsement or negative endorsement associated with a particular authenticated post. Multiple users can comment, whether they themselves are referenced in the post or not, and all their digitally signed comments will be available in the public record. Furthermore, in the case of negative endorsements (“flags”), Vicky herself (as well as Dave and others, to the extent they agree with Vicky's post) can respond with additional evidence and data, if she/they feel that the negative endorsement is unwarranted, incorrect, or maliciously incorrect. The veracity server provides a forum for archiving and accessing potentially competing bodies of evidence offered by multiple users, which can be accessed by any third party to help understand the context of an initial post, whether that post contains source material identified and attributed to others, or not. For example, Vicky may generate an analysis of scientific data and post it with her digital signature. Other researchers as well as lay people may incorporate her post in their own online content, with suitable attribution, and some may choose to make positive or negative endorsements against Vicky's original work or the derivative works.

### Guarding Against False Denials

There is a concern that a “bad actor” could attempt to subvert the system by issuing a “false denial” that challenges the veracity of an accurate post. For example, Vicky might see Zed performing a crime, manage to capture the event on video, and subsequently post the video online with her digital signature. In response, Zed might post a negative endorsement, asserting without evidence that he is not the person depicted in the video, or asserting without evidence that the video is doctored. Alternatively, if Zed had had the forethought to leave his cell phone at home before venturing out to do the crime (or perhaps give it to an accomplice traveling to a different location), he might be able to offer a “false alibi” by referencing the location data from his cell phone (which he would not be carrying at the time he committed the crime).

One can also envision coordinated “troll attacks” where a valid post is challenged by a large number of bad actors (human or automated) in order to reduce the confidence that viewers might have in an accurate post, even if e.g. Vicky has high standing in the community.

More subtly, one can envision coordinated disinformation campaigns where a fallacious post is generated, and supported with a large number of positive endorsements generated by bots or a troll farm.

While trained human viewers and fact-checkers might be able to assess the quality of positive and negative comments associated with a post, and discount false endorsements and denials, it is beneficial to implement automated tools to assist in this evaluation, both to support official fact-checkers that may be employed by a platform or service, and also to assist the general public in assessing the veracity of content that they consume. Such tools can be included in the functionality of the veracity server, or alternatively, in the viewing tools discussed below.

A first automated tool to assess the quality of an original post, as well as an endorsement or challenge, is to simply note the presence or absence of supporting data. For example, a short original post without references (comprising unsupported opinion), or a simple assertion in support (or against) an original post, without providing a textual argument, can be assessed an “evidentiary score” of zero, or close to zero, while a longer original post or comment might be assigned a low to moderate score depending on its length, cogency, and apparent relevance to the original source material, and a post or comment supported by additional data, such as GPS data associated with a personal device, or additional video, or pointers to other online references, might be assigned a moderate to high score depending on the quantity, quality and relevance of the offered data—including consideration of any prior authentication of the referenced source material as one aspect of data quality. For example, the presence of authenticated evidence can contribute to an improved evidentiary score compared to evidence that is not authenticated, and the presence of evidence with a “broken” signature (indicating manipulation of the source material) can contribute to a reduced or even a negative evidentiary score. In one embodiment, the veracity server generates an automated evidentiary score for an original post as described in U.S. Pat. No. 9,639,841 (“the '841 patent). For example, a scalar “a priori” score, as taught in the '841 patent at column 8 line 5—column 9, line 27, could be used as an evidentiary score for the purposes disclosed herein, with content analysis optionally performed in cases where the veracity server has access to the source content of e.g. Vicky's post. In another embodiment, the veracity server forms an evidentiary score for an original post by assessing the number, quality and relevance of apparent references contained in the post. A post with bibliographic references (to the extent they can be identified) or embedded links to other web sites may be considered to have a higher evidentiary score than a similar post without such references; furthermore, references to previously-authenticated content may be considered to have a higher evidentiary value than similar references to non-authenticated content. It is also desirable to assess the relevance of the references to the apparent subject matter of the post (to the extent it can be done in an automatic way), in order to avoid “gaming of the system” by bad actors that may insert large numbers of irrelevant references, simply to generate a high evidentiary score. Depending on the nature of the post, relevance can be assessed by various methods such as keyword comparisons, clustering of authors or publications and web sites, subject matter assessments, spatial and/or temporal clustering (for, e.g., posts related to specific events), and cross-references between the references themselves (including in cases where the references have been previously authenticated or cited in an authenticated post). An emerging concern is the evaluation of meaningless computer-generated texts (and apparent supporting data) that might be offered by a bad actor. For example, a probabilistic context-free grammar (PCFG), alone or in combination with other techniques, can be used to randomly generate apparently original posts, and apparently responsive comments, that are substantively meaningless, but superficially appear to be human-generated. Currently, such texts can be automatically identified with moderate confidence using artificial intelligence and machine learning, relying on analysis of e.g. lexicon, word distribution, grammatical structure and similarity within a text, grammatical errors, and similarity to previously-verified real and/or computer-generated texts. Therefore, a confidence value, for the likelihood that an original post or comment is real as opposed to computer-generated, can be used by itself as an evidentiary score, or can be combined with other metrics (e.g., a linear combination of metrics related to spelling, vulgarity, relevance and uniqueness). For example, if a linear combination of other metrics has been formed, in one embodiment, the linear combination is multiplied by a confidence metric that the original post or comment is generated by a human actor as opposed to a computer algorithm.

A second automated tool to assess the quality of an endorsement or challenge is to evaluate the relationship or “standing” of the user posting the endorsement or challenge to the original post. For example, Vicky and Dave would be considered to have high standing, whereas a third party not referenced in the original post would be considered to have lower standing. In one embodiment, the standing score is binary, and only those directly referenced in a post could receive a score of 1, while all others receive a standing score of zero. In another embodiment, those that are directly referenced may receive a relatively high score, and those not directly referenced may receive a relatively low score (although not zero, as some valid third-party evaluators could have particular insight into the veracity of the original post).

A third automated tool to assess the quality of an endorsement or challenge is to evaluate the geographic proximity of the commenting user to the subject matter of the original post—to the extent that: a) geographic location can be ascertained for the original post and the commenting user; and b) it is relevant. If the original subject matter of Vicky's post can be localized in space and time, either electronically (e.g., through time-stamped location data associated with a video), or through an embedded assertion by Vicky, then challenges originating from users that can demonstrate geographic and temporal proximity to the subject matter of the original post would be assessed to have a higher “eye witness” score, as compared to users that cannot demonstrate such proximity.

A fourth automated tool to assess the quality of an original post, or an endorsement or challenge, is to rely on the presence or absence of “certificates of status” as taught in U.S. Pat. No. 9,639,841. For example, an original post offered with a certificate of status would be assigned a higher “status” score than an original post without any such certificate. Furthermore, the status score assigned to an original post may depend on the awarding entity, its relationship to the site accepting the post, and its relevance to the subject matter of the post (to the extent it can be determined). Similarly, an endorsement or challenge that is offered by a user with a certificate of status can be assigned a higher “status” score than a comment that is offered without any such certificate. In some embodiments, the type of status certificate, or the identity of the awarding entity, can be used to adjust the status score that is assigned. In a simple example, if Vicky offers an original post on WebOneNews and Dave comments on the post, and offers a certificate of status awarded to him by WebOneNews, his status score would be higher than an alternative case where he offers a certificate of status from some other site (or no certificate of status at all). In a more complicated example, if Vicky offers an original post on WebOneNews related to international relations (as determined by keywords or syntactic indicators in her post), and Dave offers a comment along with a certificate of status from a periodical or web site dedicated to international relations, his status score would be higher than an alternative case where he offers a certificate of status from a site dedicated to physical chemistry.

A fifth automated tool to assess the quality of an endorsement or challenge is to rely on the number of endorsements and challenges offered by an entity over a previous time period, T, such as a week, month or year, up to and including the currently-submitted endorsement or challenge. In one embodiment, based on the premise that entities offering large numbers of endorsements or challenges (or both) may be associated with bots or troll farms, a “taciturn” score can be assigned, such that the taciturn score is inversely related to the number of endorsements and challenges offered by an entity over the time period T. For example, in one embodiment, if the sum of the number of endorsements and challenges offered by an entity over a particular time period T is N, a taciturn score could be computed as 1/N. In another embodiment, the taciturn score is quantized in bands, so that, for example, a value of N less than 10 results in a score of 1, while a value of N between 10 and 19 inclusive results in a score of 0.5, and a value of N greater than 19 results in a score of 0.1. Those skilled in the art will recognize that other embodiments could employ other mathematical relationships and special cases/exceptions. For example, in one embodiment, individuals or organizations that are associated with authenticated fact-checking functions (e.g., based on a suitable certificate of status or white list) may be assessed a default taciturn score such that their posts are not deemphasized due to large numbers of postings.

A sixth automated tool to assess the quality of an original post, endorsement or challenge is to rely on white lists or black lists of known entities. For example, a submitting entity on a white list would be accorded a high “trustworthiness” score, while an entity not on any white list or black list would be accorded a medium trustworthiness score, and an entity on a black list would be accorded a low trustworthiness score. A certificate of status, as discussed above, is a form of “white list”. Thus, there is some overlap between “status” and “trustworthiness”, although they are different metrics.

A seventh automated tool to assess the quality of an endorsement or challenge, associated with a current post containing previously-signed and cited content, is to determine the number of “descendants” or modifications between the current signed post and the original source material carrying positive or negative commentary. Lengthy “chains of evidence” may be considered to weaken the veracity of a current post—particularly in cases where the veracity of original source material is in dispute. Good actors will tend to favor direct referral to original source material, whereas bad actors may attempt to make arguments based on source material that has been frequently modified, and may also attempt to camouflage bad content by constructing a long string of derivative posts (descendants) with co-conspirators adding positive endorsements, thereby “burying” original negative commentary on poor source material. Thus, a “freshness” metric can be computed, such that the metric is inversely related to the number of descendants between the current post and the oldest source material cited by any positive or negative commentary. As with the non-profligate score, several alternative mathematical relationships are feasible.

An eighth automated tool to assess the quality of an endorsement or challenge, is a “combined” metric representing a mathematical function of other quality scores—for example, a linear combination of the seven quality scores noted above. A combined metric can also be generated using a nonlinear formula. A combined metric is useful as an overall assessment of the quality of a comment, and can also be used to rank-order the overall quality of multiple comments associated with a post. On the other hand, the individual metrics provide insight into the strengths and weaknesses of an original post or comment.

A subset of the metrics identified above can also be applied to an original post (as opposed to a post comprising commentary on an earlier post). For example, the evidentiary score, status score, and trustworthiness score, as well as a combined score based on these metrics, can be applied to an original post. In one embodiment, one or more scores are generated in relation to original posts that do not comprise any previously-authenticated material.

In an embodiment where the veracity server is adapted to generate at least one quality metric as discussed above, the one or more quality metrics can be generated at the time a post is submitted, or at the time a query regarding a post is serviced. The one or more quality metrics can be returned to a user in response to a query. In an embodiment where a veracity score is determined by local tools/software on a client device, such as an application embedded in a web browser that does not receive a veracity score from a remote server, the veracity score may be generated at the time a post is viewed by a user. Those of skill will recognize that a veracity server may be in a better position to evaluate some of the metrics noted above, such as a taciturn score, than a tool hosted on a client device.

While some digitally-signed posts are “original” in the sense that they do not refer to any earlier posts or previously-authenticated work, many posts are made in response to other posts. A post may be signed (authenticated) or unsigned, and if it is responsive to an earlier post, it may be purely informational (i.e., with no expression of support or disagreement), or comprise a simple expression of positive or negative support (a “like” or “dislike”), or something more—for example, a challenge citing contrary evidence, wrapped in a digital signature. In one embodiment, a digitally signed “like” is treated as an agreement/endorsement with a low or zero evidentiary metric, and a digitally signed “dislike” is treated as a disagreement/challenge with a low or zero evidentiary metric. In one such an embodiment, in addition to expressing authenticated approval or disapproval for a post (e.g., post “B”), such a like or dislike will also affect the veracity score of previous post (e.g., post “A”) to which post B refers. In another embodiment, signed and unsigned “likes” and “dislikes” may be registered relative to a specific post and reported as a matter of public interest (either combined, or reported separately for signed and unsigned sets), but are considered separately from digitally signed/authenticated endorsements and challenges that comprise additional commentary or evidence, and even signed likes and dislikes would not affect the veracity score of a previous post to which a “liked” or “disliked” post refers.

When there are multiple signed comments (positive or negative) related to an original signed post, another metric pertinent to the original post is a combined metric comprising all the positive and/or negative signed comments associated with it. For example, a veracity score can be formed based on the “combined” scores/metrics of the original signed post and the individual positive and negative signed comments, as well as the total number of such comments. In one embodiment, a veracity score is formed according to the following algorithm:

Case 1: Post with no positive or negative comments

VeracityScore=Sₐₚᵣᵢₒᵣᵢ(post)

Case 2: At least one positive comment; no negative comments/challenges

$$VeracityScore = {S}_{apriori} ( post ) + {W}_{p o s} \cdot log ( 1 + {N}_{p o s} ) \cdot \frac{1}{N} \cdot {\sum }_{i = 1}^{N} {C}_{p o s , i}$$

Case 3: At least one negative comment; no positive comments/endorsements

$$VeracityScore = {S}_{apriori} ( post ) - {W}_{n e g} \cdot log ( 1 + {M}_{n e g} ) \cdot \frac{1}{M} \cdot {\sum }_{j = 1}^{M} {C}_{n e g , j}$$

Case 4: At least one positive and one negative comment

$$VeracityScore = {S}_{apriori} ( post ) + {W}_{p o s} \cdot log ( 1 + {N}_{p o s} ) \cdot \frac{1}{N} \cdot {\sum }_{i = 1}^{N} {C}_{p o s , i} - {W}_{n e g} \cdot log ( 1 + {M}_{n e g} ) \cdot \frac{1}{M} \cdot {\sum }_{j = 1}^{M} {C}_{n e g , j}$$

Here, Sₐₚᵣᵢₒᵣᵢ(post) is a scalar a priori veracity score assigned to an original signed post based on e.g. an evidentiary score, status score, and trustworthiness score, without consideration of any commentary referencing the post. A mathematically trivial veracity score for an original post would be a constant or a function of a single one of the evidentiary score, status score, or trustworthiness score. For example, a scalar multiplier of the evidentiary score alone would be considered a trivial mathematical function of the three underlying scores. A mathematically non-trivial veracity score would be a mathematical function of at least two of these underlying scores—for example, a linear combination of two or more of these scores with non-zero weighting factors, or the product of an evidentiary score and a linear combination of a status score and a trustworthiness score. Both trivial and non-trivial veracity scores are within the scope of the systems and methods taught herein.

In regard to the veracity scores for a post with signed commentary, the multiplicative factors Wₚₒₛ and W_{neg} are weighting factors applied to positive and negative signed commentary, respectively. The logarithmic factors account for the accumulated weight of evidence, while also reducing the marginal impact of signed commentary (positive or negative) when there is already a large body of positive or negative signed commentary/evidence accumulated. Finally, the additive terms in each summation are the combined metrics for individual positive and negative signed comments, respectively. These may be formed by, e.g., a linear combination of some or all of the seven metrics noted above (evidentiary, standing, eye witness, status, taciturn, trustworthiness and freshness), although the scope of the invention is not limited to a linear combination. In case 2, the polling score for an original post is its a priori score plus a positive increment based on Wₚₒₛ, a logarithmic factor based on the total number of signed comments received, and the average value of the combined metrics of the positive signed comments received. In case 3, the polling score for an original post is its a priori score plus a negative increment based on W_{neg}, a logarithmic factor based on the total number of signed comments received, and the average value of the combined metrics of the negative signed comments received. In case 4, the polling score for an original post is its a priori score plus the positive and negative increments noted above. While the embodiment described explicitly above relies on weighting factors and logarithmic deemphasis factors, other combined metrics are feasible and within the scope of the invention.

In one embodiment, the veracity server applies the same scoring algorithm to all signed posts. In another embodiment, the veracity server applies different scoring algorithms to different signed posts. For example, if signed posts may be submitted through other servers (e.g., WebOneNews, ScienceOne), different scoring algorithms may be applied depending on the submitting entity or type of entity (e.g., the general public, or a scientific organization that has previously coordinated with the veracity server or its hosting organization regarding a scoring algorithm, or a general news organization that has previously coordinated with the veracity server or its hosting organization regarding a scoring algorithm). In one embodiment where different scoring algorithms are available, the identity of the scoring algorithm applied to a post becomes part of the metadata associated with that post, and in one such embodiment, users accessing or viewing the post may access the identity of the scoring algorithm, and the details of the algorithm describing how a veracity score is determined.

### Handling of Informational and Unsigned Posts

A signed original post is “informational” in the sense that it is not commenting on any previous post. In one embodiment, its veracity score is assessed as noted above using metrics for evidence, status, and trustworthiness (although additional and other scoring mechanisms may fall within the scope of the systems and methods discussed herein). In addition to original posts, it is conceivable that a user may wish to post a signed informational comment against a previous signed post (or a signed comment on a previous signed post), with the goal of providing related content that may be of interest to others, without expressing a positive or negative opinion on the original post or intermediary comment. Such an informational comment may also be assessed according to e.g. evidence, status, and trustworthiness, although such assessment would not affect the veracity score of the original post or intermediary comment. A third user may choose to post a positive or negative signed comment against the original post, citing the content provided in the informational post. Such a positive or negative comment would enjoy the evidentiary status of the informational comment, and would affect the veracity score of the original post.

In a preferred embodiment, unsigned posts and comments are treated as “noise” and are ignored for purposes of determining a veracity score for themselves or other posts. This will tend to encourage users and organizations, who are “good actors,” to take ownership of their opinions. It will also tend to highlight those users who are unwilling to take ownership for their online activity.

In a transitional case relevant to the introduction into widespread use, of the systems and methods discussed herein, a signed comment can be lodged against an unsigned post or comment and treated as an original signed post. Furthermore, in a scenario where an unsigned comment (positive or negative) is lodged against a previously-signed post or comment, subsequent signed commentary that responds to the unsigned commentary is treated as an original signed post, and neither the unsigned comment nor the subsequent signed comment (responding to the unsigned comment) affects the veracity score of the original post. This prevents corruption of the chain of evidence that would normally be maintained by the nested signatures of the commenting parties.

In a scenario where Vicky signs an original post, Dave signs a responsive comment, and Zed lodges an unsigned comment against Dave's comment, Zed's comment would not affect Vicky's veracity score in a preferred embodiment. Another party (“Michael”), seeing Zed's comment, has several choices of how to extend the discussion. For example, Michael could: a) make an unsigned comment against Vicky, Dave or Zed (with or without referencing Zed); b) make a signed comment against Vicky's post or Dave's comment (with or without referencing Zed); or c) make a signed comment against Zed's comment. In case (b), Michael's positive or negative comment would affect Vicky's veracity score. However, in case (c), Michael's comment would not affect Vicky's veracity score since Zed's unsigned comment could have distorted the discussion. Instead, the signed comment against Zed would be treated as an original post (albeit one that is commenting on Zed). Zed's unsigned comment, by itself, is a dead-end that cannot serve as a bridge from later commentary back to Vicky's original post. However, any user is able to reference Zed's comment as “extraneous unverified content” while offering a comment against Vicky's original post or Dave's comment, if they choose to do so.

### Viewing Tools and Comment Generation Tools

Viewing and comment generation tools can be incorporated into the veracity server, or other servers accessed by users (which may in turn communicate with a veracity server), or a web browser itself.

Web browsers can include a function (as original capability or as an add-in module) to automatically query a single, default, or selected veracity server, or multiple veracity servers, whenever the user of the browser views a post with authenticated content (e.g., Vicky's original post or a derivative/descendant of her original post). In one embodiment, the query comprises the most recent (outermost) digital signature of authenticated content contained in a post. In another embodiment, the query can comprise a plurality (more than one, up to and including all) of the digital signatures contained in a post. The query response can comprise any subset of the stored data associated with, or related to, the digital signatures contained in the query. For example, in one embodiment, if the query contains the most recent (outermost) digital signature of authenticated content contained in a post, the query response would include the stored data associated with all the digital signatures referenced in the authenticated content, including the bibliographic data and pointers, and associated positive and negative endorsements. In another embodiment, the query response would only contain the stored data that is directly related to the digital signature(s) listed in the query. In one embodiment, the veracity server provides selection criteria that may be used to tailor a query and the consequential query response.

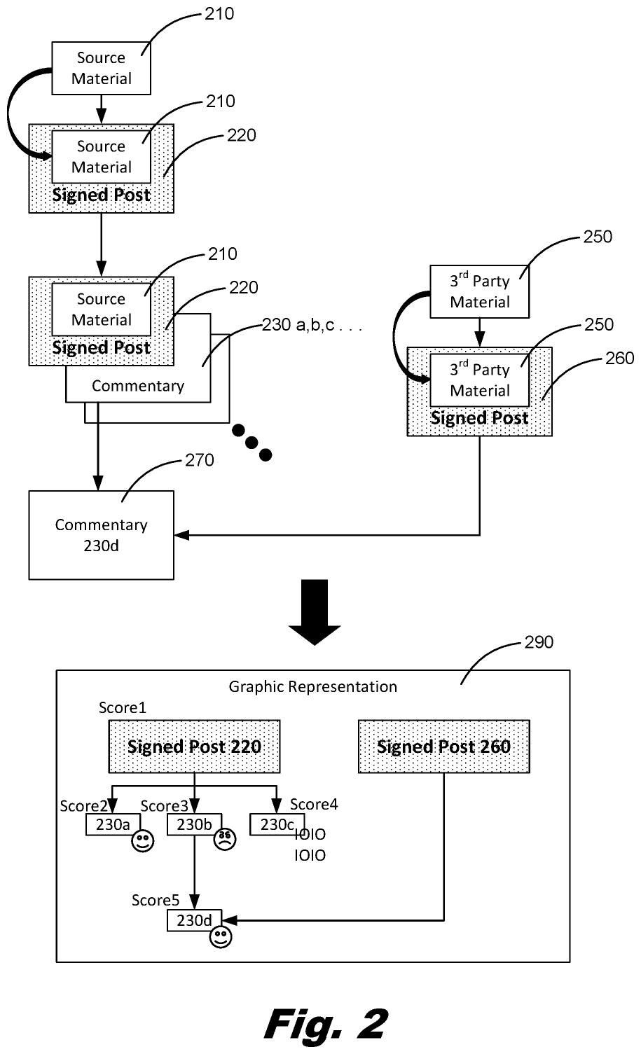

Five general outcomes can occur in response to a query: 1) the veracity server does not contain any record of authenticated content associated with the digital signature(s) contained in the query; 2) at least one record exists, for example an original post and one or more “informational” comments that do not explicitly express a positive or negative opinion, but there are no positive or negative comments logged against the identified content; 3) there are one or more positive endorsements and no negative endorsements; 4) there are one or more negative endorsements and no positive endorsements; and 5) there is at least one positive endorsement and at least one negative endorsement. While there are many ways that this information can be conveyed to a user, in one embodiment, a distinctive icon, displayed to the user, indicates which of these situations has occurred. In another embodiment using icons, some of these outcomes may be grouped together. For example, a simplified interface could employ only two icons—one indicating the lack of negative endorsements (with a “grayed-out” icon indicating no comments at all), and the other indicating one or more negative endorsements. Furthermore, in one embodiment that uses icons, in the event of at least one comment, clicking on the icon will bring up a new window or sidebar that allows the user to view the commentary stored by the veracity server. The information can be presented with a combination of text and graphics. For example, in one embodiment, the information is presented as a simple listing of comments possibly ordered by age or quality score. In another embodiment, the information is presented in the form of a graphic showing referential relationships in the chain(s) of commentary, with options to expand particular nodes to see embedded commentary. Note that a graphic structure may be needed to represent a situation where a comment on a post also references other publicly-available and authenticated content as shown in FIG. 2. Here, an original authenticated post 220 containing source material 210 accumulates some commentary, 230a, b, c. For illustrative purposes only, we may consider a scenario where all the commentary 230 references the original post, but not any of the other commentary. Even though it is not explicitly indicated, the commentary is presumed to be signed/authenticated and logged in the veracity server. Later, another commenter responds to comment 230b while also referencing 3^{rd} party source material contained in a signed post 260, and posts his own signed comment 230d. The resulting graphic structure could be represented as shown in graphic representation 290. In an embodiment, the nodes in the graphic representation are differentiated according to their nature—for example, positive endorsements are indicated in green, or with an embedded smiley face or “thumbs-up” icon; negative endorsements are indicated in red, or with an embedded frowny face or a “thumbs-down” icon; and “informational” comments are indicated in black and white or with an icon comprising an italic “i” in a circle, or binary data. See, e.g., comments 230a, 230b, and 230c, respectively. In one embodiment, a node may contain a short summary, keyword, or key phrase (if provided by a user or automatically generated), and clicking on a node will bring up the full related comment in a popup window. For example, a user-supplied summary might comprise a textual phrase such as “statistical disproof” or “scientific analysis”, while an automatically-generated summary might say “eye-witness” or “high status”, for example, if the veracity server determines a suitable metric for those attributes relative to an applied threshold. If both user-supplied and automatically-generated summaries are available for a node, they can be distinguished by, e.g., keyword or font. A veracity score, if generated for a node (a post or comment) can be portrayed as a numerical value within or adjacent to the graphical device indicating the node. In FIG. 2, these numerical values are indicated by the legend ‘xxx’.

Based on the information presented, the user can then make his/her own judgement as to the veracity of the information in the post 220, as well as the other information provided in the commentary.

The web browser can also display, as a default or upon request, the age of the post(s) as recorded by the veracity server and reported in the item 160 response. Posts that are very recent could be viewed with caution, since all relevant parties may not have had an opportunity to comment.

If a post as a whole is not authenticated, the veracity server lacks the fundamental indexing tool needed to store the post, and users cannot provide commentary using the (non-existent) digital signature as a pointer. Furthermore, a web browser as described above would lack the ability to query the server using a digital signature for the post as a whole (since none is provided). In one embodiment, the web browser is adapted to indicate the lack of an overall digital signature for a post by generating a visual or audible alert, indicating to the user that no individual has taken authenticated ownership of the post. Depending on the context, this could be considered an indication that the data and/or sentiments expressed in the post should be viewed with caution—or perhaps ignored completely.

In a more elaborate web browser function or viewing tool, if a post as a whole is not authenticated, but elements within it still carry valid signatures, the viewing tool is configured to query the veracity server for those valid signatures, and process/display any available commentary as generally described above.

In an embodiment where viewing and/or content generation tools are hosted on a server (such as the veracity server or another server), the server can generate a web page that can provide similar functionality as described above, which may be viewed in a standard web browser.

After viewing a post containing authenticated content, a user may wish to post a comment. In one embodiment of the systems and methods disclosed herein, a web browser may be adapted to provide editing and comment generation tools to assist in this effort. For example, in addition to standard comment generation, copying, and pasting tools, the web browser also comprises tools to support proper referencing of authenticated content, generate hashes of selected content, build hash manifests, insert a standard indicator of the type of comment (e.g., positive, negative or informational), query a suitable certifying authority for a public/private key pair, generate a digital signature over the generated comment, and automatically or semi-automatically (i.e., requiring user approval) post the assembled comment to one or several veracity servers (perhaps in addition to posting the assembled comment on another server of the user's choice). In one embodiment, the suitable certifying authority is a veracity server. In another embodiment of the systems and methods disclosed herein, a server (such as a veracity server or another server) provides tools for comment generation, hash generation of selected content, construction of hash manifests, insertion of a standard indicator of the type of comment, generation of public/private key pairs, generation of a digital signature over the generated comment, and automatic or semi-automatic posting of the assembled comment to one or several veracity servers (perhaps in addition to posting the assembled comment on another server of the user's choice).

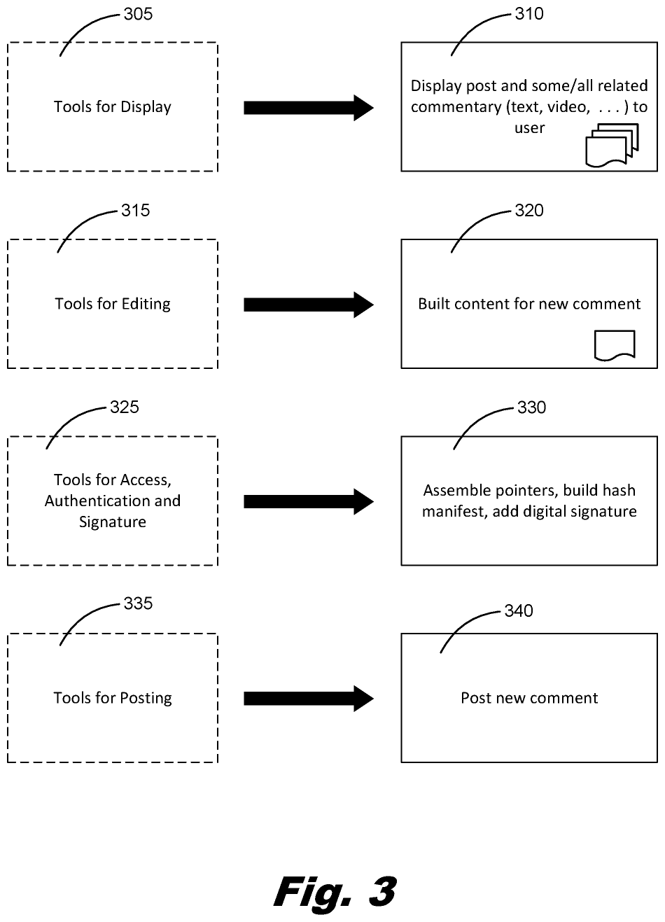

The primary processes in building a comment with authenticated content are illustrated in FIG. 3 As illustrated, tools for display, 305, are used to display an existing post and some or all of its related commentary to a user (block 310). At block 320, tools for editing, 315, are used to build a new comment and indicate the nature of the comment (positive, negative, or informational). The new comment can contain selected portions or the entirety of the existing post and its associated commentary, as well as other material generated by the user or captured from other online sources. Authenticated content can be copied verbatim along with its associated hash, or paraphrased without its hash, but with e.g. a pointer to the authenticated content so that a subsequent user can verify that the paraphrasing is consistent with the original source material. Of course, copying authenticated source material verbatim, along with its hash, and then editing the source material, would “break” the hash and indicate manipulation. At block 330, tools for access, authentication and signature (325) are used to build pointers to online repositories (if needed), assemble hash manifests, append ID information (i.e., to support retrieval of a public key, among other desirable capabilities), acquire public/private key pairs, and construct a digital signature for the new comment with the user's private key. At block 340, the new signed comment is posted to one or several servers/online repositories (and associated web sites) using tools for posting 335. This can include automatic or semi-automatic posting to one or several veracity servers, with concomitant indexing and cross-indexing as discussed above.

The various tools indicated in FIG. 3, tools 305, 315, 325, and 335, can be supported by a web browser or a server or a combination of a browser and a server. To the extent that the tools are hosted by a server, a standard web browser as known in the prior art may be employed by a user to perform the associated functions.

### Forward and Backward Evaluation Options

The preceding discussion has primarily although not exclusively focused on a single post that has accumulated positive and/or negative commentary. However, in many use cases, an original post might be embedded in a subsequent authenticated online work (or post) with modified content (either deleted or added), as described in U.S. Pat. No. 10,033,537. If a bad actor's original post received significant negative endorsements (challenges), the bad actor might attempt to evade responsibility, and “rehabilitate” the post, by either: a) modifying it in some minor way and posting the modified content as an acknowledged “descendent” of the original post, with a new digital signature; or b) simply reposting the original content as a “clone” with a new digital signature (if this results in a digital signature with a different numerical value—for example, if the authentication algorithm relies on current time).

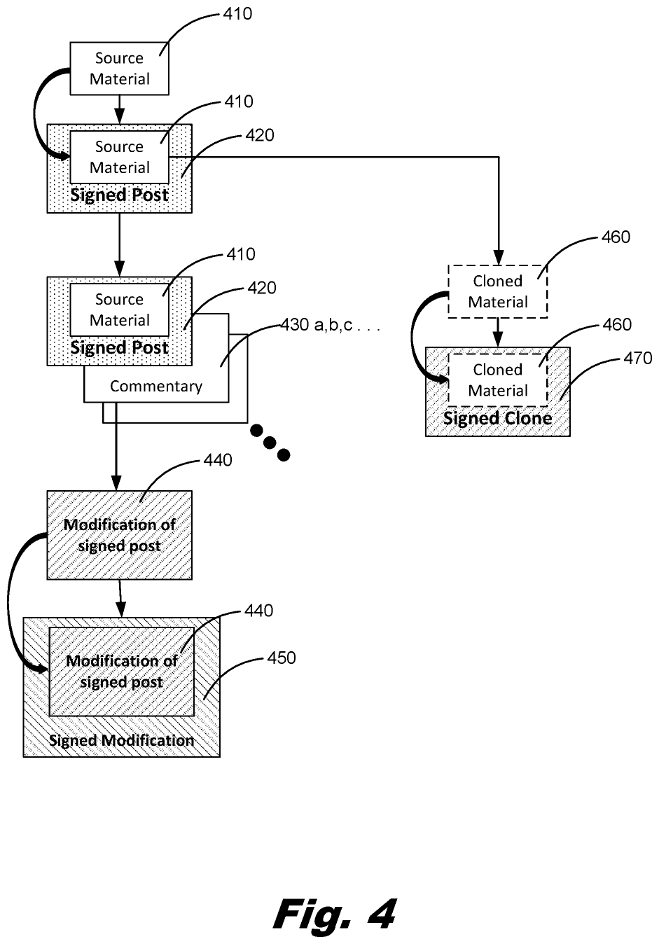

Referring to FIG. 4, consider the use case where Zed (a bad actor) generates a signed post 420 containing some source material 410. The source material could be material with no direct attribution, or alternatively, the source material could comprise the signed work of others (with or without modification and/or embellishment). Over time, Zed's signed post accumulates negative commentary, 430a, b, c, which is logged on the veracity server and accessible to third parties. In order to evade responsibility and (he may hope) leave behind the negative commentary, Zed or an accomplice (with a different ID) could modify the signed post (440) and sign and post the modification (450). Alternatively, Zed could simply make a clone or copy of the source material in his original post (460) and generate a new (cloned) post 470 that is substantially identical to the first, but with a unique digital signature.

If the accumulated negative endorsements, 430a, b, c, cannot be associated with the descendent or cloned post 450 or 470, the prior work of the online community (and possibly the efforts of people directly impugned by the post) might tend to be suppressed.

The “descendant” issue is partially addressed by the freshness metric discussed above; however, additional protection can be implemented—at least in cases where the bad actor has cited to prior signed and authenticated work—in an embodiment where the veracity server records and indexes all digital signatures in a post, and cross-references new posts, containing signed and authenticated content, to other posts with the same signed and authenticated content. This allows for retrieval of related commentary that could have a bearing on the original source material. This works for both descendant and cloned posts, if the original source material contains at least one digital signature that can be recognized and indexed by the veracity server.

The problem of cloned material without attribution is partially addressed, in at least some use cases, by other metrics that may be available—for example, metrics related to evidentiary quality, status, and trustworthiness. In one embodiment, the veracity server performs a search of all previously-received original posts with the goal of identifying identical, or substantially similar, unsigned source material. In this embodiment, the veracity server can report a putative relationship to accumulated commentary with a “similarity score” based on the degree of similarity between the new post and the previously-logged post. The degree of similarity can be evaluated numerically based on one or several metrics such as size (bytes), word count, degree of correlation in lexicon, correlation in word pairs, and correlation in sentences.

In order to facilitate online discourse with signed commentary as described herein, either the veracity server or a web browser can be adapted to facilitate the construction and posting of signed/authenticated comments. For example, a veracity server can be adapted to support the generation of public/private key pairs for users accessing its service. Furthermore, either a veracity server or a web browser can be adapted to support editing and commenting tools that allow a user to construct a comment referencing previously-authenticated and posted material, generate a hash manifest and suitable bibliographic data/pointers for the comment, digitally sign the comment, and upload the comment to the veracity server.

### FURTHER EMBODIMENTS

In a further embodiment, the veracity server deterministically or optionally (at user request) provides notifications to users that have submitted digitally signed posts and comments, sending such notifications to the email of record for the relevant certification. Such notifications can, without limitation, notify a user of new authentications, failed authentications, and pointers to new posts and comments by others that cite to the previous authenticated content of the user.

In another further embodiment, the veracity server or a different server may be adapted to award a certificate of status to a user that consistently offers signed posts that receive significant positive commentary and earn high veracity scores. In one embodiment, this award is automatically generated. In another embodiment, this award is manually authorized by a human employee of an organization operating the veracity server or another server, although the veracity server may alert a human employee of the organization operating the veracity server or another server that an award may be warranted. In one such embodiment, a server operated by e.g. WebOneNews monitors the veracity scores of users making original signed posts to the veracity server with citations to content initially authenticated by WebOneNews, and awards a certificate of status either automatically or with human approval to authors of such posts that consistently receive significant positive commentary and earn high veracity scores. In another such embodiment, a human employee of an organization empowered to issue a certificate of status may rely on a web browser to access statistical data maintained by the veracity server, and made available to the general public (or alternatively, only authorized users), to identify users that have made original signed postings to the veracity server that satisfy the organization's own criteria for awarding of such a certificate. In one embodiment where the veracity server is adapted to support the award of a certificate of status as described, the veracity server maintains statistical data regarding the scores, volume of commentary, and bibliographic data (including authenticated references cited), of original signed posts by the users.

In another further embodiment, a human user may signal the veracity server that a post should be treated as an original post, even though it cites to previously-authenticated content (possibly including original posts and comments pertaining thereto). This is analogous to “starting a new thread”, and is useful in cases where, e.g., a new line of discussion is intended, and also in cases where source material is taken from several diverse lines of discussion. In one such embodiment, the user signifies his/her intent by selecting a button or icon available on a graphical user interface of a web browser or editing tool used to build an original signed post, and this intent is communicated to the veracity server as part of the metadata transmitted to the veracity server along with the content of the post.

In another further embodiment, a human user may signal the veracity server that scored commentary is blocked on a particular original signed post, or that all commentary is blocked. For example, a user may wish to protect uploaded content such as vacation videos and opinion pieces with a digital signature, without allowing scored commentary (or any commentary/debate) on the content. This can be used to prevent (or at least help to identify) subsequent manipulation of such content, while also signaling to the veracity server and other users that the content is not considered the subject of factual debate. In one such embodiment, the user signifies his/her intent by selecting a button or icon available on a graphical user interface of a web browser or editing tool used to build an original signed post, and this intent is communicated to the veracity server as part of the metadata transmitted to the veracity server along with the content of the post. Subsequently, this metadata is made available to other users that download or access the post, and may be signaled to such a user through a distinctive icon (e.g., on a web browser or text editor adapted to display the post) indicating that scored commentary (or all commentary) is blocked. In one embodiment where a user may block scored commentary or debate on a post, veracity scoring of posts is limited to those posts that allow scored commentary and debate (i.e., posts that block scored commentary and debate are not scored). This allows a user to protect online content, but prevents the potential accumulation of a reputation for high veracity from posts that are not subject to scored rebuttal. In another embodiment where a user may block scored commentary or debate on a post, veracity scoring of such posts occurs, but is treated separately from posts where commentary is allowed. For example, separate statistics are maintained, and the veracity score of such posts, when presented to other users, are marked or distinguished from other scores so that users recognize that scored debate has been blocked, and algorithms for awarding certificates of status for veracity may (in some embodiments) not consider such posts.

In an embodiment where commentary or debate on a post can be blocked, it is still possible for a user to cite or embed the commentary-blocked content in a subsequent signed comment. In one such embodiment, such a signed comment against on original post with blocked commentary is treated as an original post in its own right, and can be scored for veracity as an original post (unless the commenting user also blocks debate). Consider a scenario where Vicky posts original signed content of her vacation at the beach and blocks commentary, thereby sharing her experiences with her friends in a nonjudgmental way, while protecting her content from subsequent manipulation. Others are free to share Vicky's post (post “A”), and even comment on her post (and embed it in their own postings and comments). Assume that Dave and Zed both comment on Vicky's post (posts “B” and “C”), allowing commentary and debate on their posts so that they can potentially garner status depending on the quality of their posts and subsequent feedback. The veracity scores for posts B and C do not affect the veracity score of Vicky's post A, or Vicky's status, even in cases where Vicky's original post “A” is scored.

In another further embodiment, the veracity server maintains an archive of the time history of the veracity scores associated with an original post or comment, and this archival data is made available to users. Thus, for example, a post that is initially “attacked” by a troll farm, but subsequently “rehabilitated” by the work of independent fact checkers, will experience an initial drop in its veracity score, followed by a rebound, and this time history will be available for viewing by the users of the veracity server.

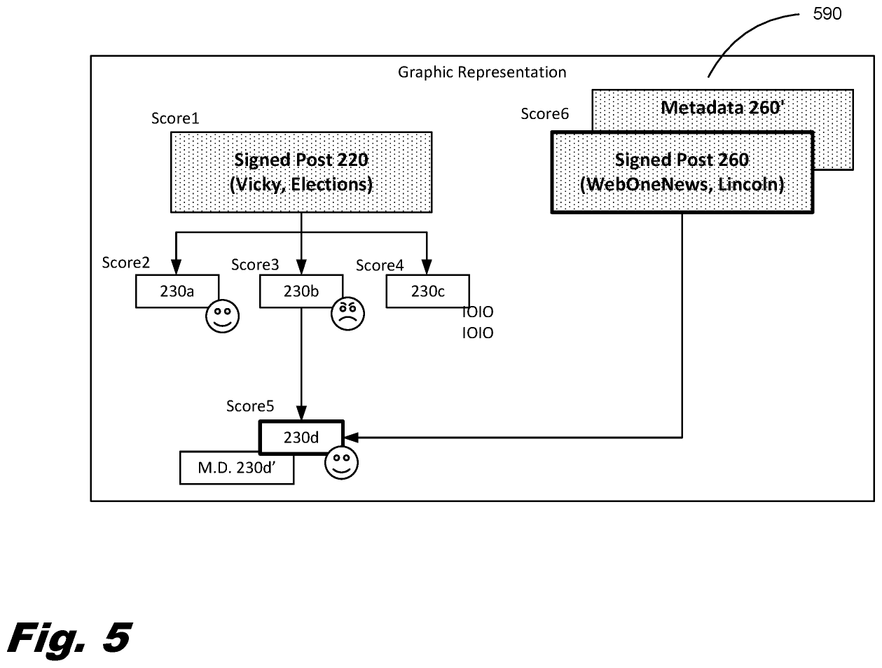

The metadata associated with an original signed post or comment, and maintained by the veracity server, can be used to support a variety of useful information that can be presented to a user. Referring to FIG. 5, a graphic representation of two original posts and several related comments, similar to that of FIG. 2, is shown. Here, Vicky has created a signed post 220 related to elections. She has allowed commentary and scoring. Her name as the author, and a subject matter keyword, are illustrated. The veracity score (e.g., Score1) for her original post, as well as the commentary 230a, b, c, and d, (e.g., Score2, Score3, Score4, and Score 5 respectively) is shown. Note that the scoring of the commentary affects the score of Vicky's original post at the time of viewing. The user viewing this information has selected two particular nodes—260 and 230d—as indicated by the heavier borders, and these nodes are shown with additional metadata available for viewing (260′ and 230d′). This additional metadata includes, e.g., the time of posting, the scoring method, and bibliographic data (if any). In some embodiments, clicking on (or selecting) the metadata element will bring up a more fulsome display, if available, and clicking on (or selecting) a node representative of a post or comment will generate a popup window (not shown) of the entire post (which a user could chose to minimize, if desired), along with a menu of additional viewing and editing/creation tools (also not shown) for exploring the associated metadata in more detail (including e.g. a time history of scores), and for creating a new post or comment.

### CONCLUSION

The teachings herein provide a user-friendly way for third-party users to evaluate competing information related to questionable postings. An auxiliary benefit is that, by simply using the system, normal users (lay persons) become more attuned to the potential for disinformation in the content that they consume, and become more capable of assessing online postings with a critical eye.

In one implementation, a website such as WebOneNews may access the veracity server to request authenticated commentary on posts and/or comments that had previously appeared on WebOneNews, making such content easily accessible for users of the site. In another example, in a scenario where e.g. a Facebook® user has authenticated a Facebook® post and uploaded the post to the veracity server, Facebook® automatically accesses the veracity server at periodic intervals, while the user is active on the site, to check for subsequent authenticated commentary, and make such commentary available on the user's feed. Those of skill will recognize that other implementations can be used to provide convenient access to such content. For example, the veracity server could “push” such content to relevant sites as it is generated, or such content could be provided only upon request of the user.

In one implementation, an application on a user/commenter's mobile device may be used in conjunction with the system described above. For example, the mobile application may be used to conveniently collect, store, and manage a user's portable status certificates and cryptographic keys. In some embodiments, the mobile application may analyze comments before the user submits them and may recommend changes to the comments to achieve a higher score. For example, the mobile application may check the comments for relevance, misspelled words, vulgarity, and for compliance with the terms of service for a particular website. The mobile application could also search for other authenticated content on other sites that may be related to the current comment. The app could then help the user cite relevant references in making comments, or take the user to an alternative location to do research or engage in the new comment thread. As described herein, execution of the app or the veracity server may result in the generation an a priori score for the submitted comment wherein the at least one comment comprises at least one discrete thought originating from at least one online document different from the at least one comment. A scoring module, executed by the processor of the veracity server, may also analyze the status of the user and to adjust the a priori score to reflect the status of the user to produce an a posteriori score.

The interactions disclosed above, between different users, and between users and a veracity server, illustrate the functionality and operation of possible implementations of systems, methods and computer program products according to various embodiments of the present invention. In one embodiment, the comment construction and posting functionality described herein can be provided by a server associated with an organization maintaining an online presence (e.g., WebOneNews or ScienceOne). For example, a server for such an organization could be adapted to automatically or semi-automatically (i.e., with human involvement of dedicated fact-checkers) respond to postings citing its prior online content. Comments of organizational fact-checkers would have “standing” since they are posted by members or associates of the organization, and reference the authenticated work of the organization. It is envisioned that members of the general public could also post comments relating to content available on the server (as well as possibly other content). In a second embodiment, a third-party organization dedicated to e.g. journalistic excellence (perhaps a non-profit) maintains a veracity server as well as a cadre of fact-checkers that could respond to commentary throughout the web, building comments and posting them to assist the general public in understanding the quality of content available on the web. While such an organization (and its comments) might not always have “standing” for a particular comment, the organization might have high status and be represented on a white list, and for these and other reasons, it might enjoy high recognition and trust by the general public. In this embodiment, members of the general public may also be able to post original content and responsive comments. In a third embodiment, a third-party organization (which may or may not have its own cadre of dedicated fact-checkers) maintains a veracity server that is exposed to other sites on the internet (e.g., WebOneNews, ScienceNews, Facebook®, Reddit®), as well as the general public, as a broadly available internet resource. In this embodiment, multiple sites share a common resource that provides the tools and resources for authentication, and can easily cross-reference (and subsequently search) posts related to, and/or submitted by, multiple sites/users. Other embodiments, with various mixes of resources and capabilities as disclosed herein, offered to various clients, are feasible and will be apparent to those of skill in the art.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The preceding description has been presented only to illustrate and describe examples of the principles described. This description is not intended to be exhaustive or to limit these principles to any precise form disclosed. Many modifications and variations are possible in light of the above teaching.

1. A system comprising a veracity server, comprising:
a processor;
a memory; and
a network interface device;
wherein the veracity server is adapted to:
receive a post at a network interface device, comprising authenticated content, from a user accessing the veracity server via the Internet;
store the received post in a database for subsequent retrieval;
index the received post according to at least one digital signature constructed over content contained within the received post; and
respond to a query received at the network interface device, specifying the indexed digital signature, by retrieving the stored post, and generating and transmitting a response comprising the retrieved stored post;
wherein the veracity server:
verifies authentication of the authenticated content by retrieving a public key of an identified entity that generated the digital signature, from a Certification Authority in accordance with the methods specified in ITU-T X.509v3 or RFC 5280; and
verifies that a hash of the digital signature, used as authentication metadata uploaded to the veracity server with the received post and generated using a private key associated with the user, matches a hash of the authenticated content.

2. The system of claim 1, wherein the veracity server is further adapted to:
receive a nested post at a network interface device, comprising authenticated content, from a user accessing the veracity server via the Internet, wherein the nested post comprises a first outer digital signature and at least one additional digital signature within the content authenticated by the outer digital signature;
with the processor, parse the content authenticated by the outer digital signature to determine the content authenticated by the at least one additional digital signature;
check the database for pre-existing records indexed by the at least one additional digital signature; and
where the database does not contain a pre-existing record indexed by the at least one additional digital signature, create at least one new record representing the content authenticated by the at least one additional digital signature without a pre-existing record, the at least one new record indexed by the at least one additional digital signature;
the veracity server further adapted to store the nested post in the database for subsequent retrieval, index the nested post according to the first outer digital signature; and
cross-index the record of the nested post with at least one other record contained in the database, said at least one other record representing content contained in the nested post that is authenticated by a digital signature representing an index into the database.

3. The system of claim 2, wherein the veracity server is further adapted to:
generate at least one web page for display of a post that has been identified in a client query, when said client-identified post has been indexed in the database, and at least one authenticated comment, cross-indexed in the database, that references the client-identified post;
generate at least one web page adapted to support construction of a new comment referencing a previously-stored post or comment;
generate a digital signature for the new comment; and
post the new comment to an online repository identified by the client, wherein the online repository identified by the client may comprise a memory the veracity server.

4. The system of claim 1, further adapted to:
generate a portable certificate of status based on the user's post hosted by a forum server, the forum server comprising a status module to:
encrypt the portable certificate of status using a private key;
make a public key available for verification of the portable certificate of status; and
transmit the portable certificate of status to a computing device of the user communicatively coupled to the forum server; and
wherein the portable status certificate describes at least a status of an online persona of the user and is accessible on a second forum server when the second forum server receives the portable status certificate from the first user.

5. The system of claim 4, wherein the veracity server is further adapted to:
support authentication of the post via maintaining the public key associated with the post and authenticate the post when authentication is requested.

6. The system of claim 1, further comprising:
a comment analysis module, executed by the processor of the veracity server, to:
analyze content of at least one comment submitted by another user regarding the post; and
generate an a priori score for the submitted comment wherein the at least one comment comprises at least one discrete thought originating from at least one online document different from the at least one comment; and
a scoring module, executed by the processor of the veracity server, to analyze the status of the user and to adjust the a priori score to reflect the status of the user to produce an a posteriori score;
wherein the a priori score comprises at least one metric for the submitted comment, assessed on the submitted comment excluding the at least one discrete thought, the at least one metric taken from the set of metrics comprising: evidence of eye-witness status; a taciturn score; freshness.

7. A method for computing a veracity score for authenticated online content posted by a first entity, the method comprising:
generating, with a processor, a first metric adapted to assess the likelihood that the authenticated content was generated by a human being;
generating at least one additional metric, wherein the at least one additional metric is either:
based on an offered digital certificate of status associated with the content posted by the first entity online; or
the trustworthiness of the posting entity based on an assessment of the trustworthiness of the posting entity's domain; and
wherein the veracity score is a non-trivial mathematical function of the first metric and the at least one additional metric, and the processor:
verifies authentication of the authenticated online content by retrieving a public key, of the first entity, from a Certification Authority in accordance with the methods specified in ITU-T X.509v3 or RFC 5280; and
verifies that a hash of a digital signature, used as authentication metadata uploaded to the veracity server with the authenticated online content and generated using a private key associated with the human being, matches a hash of the authenticated online content.

8. The method of claim 7, wherein the computation of a veracity score, for authenticated online content posted by a first entity, further comprises:
the evaluation of at least one authenticated positive or negative endorsement, posted by a second entity different from the first entity and referencing the authenticated online content posted by the first entity;
wherein the method comprises at least one metric adapted to assess the at least one authenticated positive or negative endorsement with regard to evidentiary quality, status, or trustworthiness, and at least one additional metric adapted to assess the at least one authenticated positive or negative endorsement with regard to standing, evidence of eye witness status, a taciturn score, or freshness.

9. A computer readable storage medium storing a program of machine-readable instructions executable by a digital processing apparatus to perform data processing operations for:
receiving a first internet protocol (IP) message;
determining that the first IP message comprises a client request to post authenticated content for public access in the form of a post;
storing the post in a database for subsequent retrieval;
indexing the post according to at least one digital signature constructed over content contained within the post; and
responding to a query contained within a second IP message, specifying the indexed digital signature, by retrieving the stored post, and generating and transmitting a response comprising the retrieved stored post;
wherein the response comprises a veracity score; and
wherein the veracity server:
verifies authentication of the authenticated content by retrieving a public key, of an identified entity that generated the digital signature, from a Certification Authority in accordance with the methods specified in ITU-T X.509v3 or RFC 5280; and
verifies that a hash of the digital signature, used as authentication metadata uploaded to the veracity server with the first IP message and generated using a private key associated with the client, matches a hash of the content over which the digital signature was constructed.
